(19) United States
(12) Patent Application Publication
(10) Pub. No.: US 2021/0042682 A1
(43) Pub. Date: Feb. 11, 2021

(54) METHOD FOR COMPUTER ASSISTED WORK MANAGEMENT AND WORK MANAGEMENT SYSTEM

(71) Applicant: FRABA INC., Hamilton, NJ (US)

(72) Inventor: Christian Leeser, Duesseldorf (DE)

(73) Assignee: FRABA INC., Hamilton, NJ (US)

(21) Appl. No.: 16/536,332

(22) Filed: Aug. 9, 2019

(51) Int. Cl. G06Q 10/06; G06F 16/2455

(52) U.S. Cl. CPC G06Q 10/063112; G06F 16/2455

(57) ABSTRACT

A computer-assisted work management method in a work management system. The work management system includes a role database defining role objects, a person database defining person objects, a process database defining process objects, and an organizational unit database defining organizational unit objects. The method includes receiving a process request from an organizational unit via an electronic data interface. The process request includes specification information and triggers a predefined process object. The specification information is stored in the triggered predefined process object. A process-specific role profile is determined by evaluating all role objects linked with the triggered predefined process object. A role-specific task is determined using the process-specific role profile and the specification information. The predefined process object is linked with a person object which is associated with a role object. The at least one role-specific task is provided to the natural person who is linked with the role object.

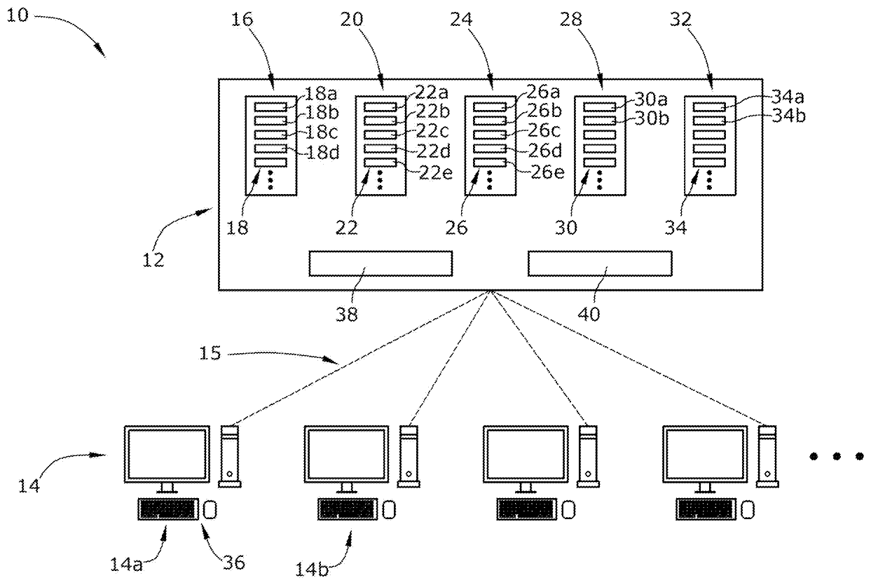

### FIELD

The present invention relates to a method for computer-assisted work management in a work management system as well as a work management system for computer-assisted work management.

### BACKGROUND

Organizations typically comprise a plurality of essentially independently operating organizational units. Each employee and all operating resources are generally uniquely and fixedly associated with a specific organizational unit, wherein, typically, identical operating resources and positions/posts exist in several organizational units.

The individual organizational units each frequently comprise independent work management systems which can only map a limited portion of the organizational structure. Within the organization, identical processes are consequently often performed several times and/or operating resources and employees are not efficiently deployed, in particular when several organizational units are involved. Resources, such as electric energy, working time of employees, number of computer systems etc., are thereby inefficiently employed/consumed in the organization. This results in relatively high costs and in turn creates an undue stress on the environment.

### SUMMARY

An aspect of the present invention is to provide an inexpensive and resource-saving work management.

In an embodiment, the present invention provides a method for a computer-assisted work management in a work management system. The work management system includes a role database in which role objects are defined, a person database in which person objects are defined, a process database in which process objects are defined, and an organizational unit database in which organizational unit objects are defined. Each of the person objects are associated with a natural person and are linked with at least one of the role objects. Each of the process objects are linked with at least one of the role objects. Each of the organizational unit objects are linked with at least one of the role objects and with at least one of the process objects. The method includes receiving a process request from an organizational unit via an electronic data interface. The process request comprises at least one specification information and triggers a predefined process object of the process objects. The at least one specification information is stored in the predefined process object which was triggered. A process-specific role profile is determined by evaluating all role objects linked with the predefined process object which was triggered. At least one role-specific task is determined using the process-specific role profile and the at least one specification information. The predefined process object is linked with at least one of the person objects, each of the linked at least one person objects being respectively associated with at least one of the role objects. The at least one role-specific task is provided to a natural person who is linked with the respective role object of the roll objects.

### BRIEF DESCRIPTION OF THE DRAWING

The present invention is described in greater detail below on the basis of embodiments and of the drawing in which:

The FIGURE shows a schematic diagram of a work management system according to the present invention.

### DETAILED DESCRIPTION

The method according to the present invention for computer-assisted work management is provided for execution in a work management system according to the present invention which comprises a role database, a person database, a process database, and an organizational unit database.

In the role database, a plurality of role objects are defined, wherein each role object is associated with a unique organizational role, i.e., a unique function within the organization. The role objects typically comprise a role-specific requirement profile as well as a role-specific authorization profile. In the role objects, role-specific accounting characteristic data or any other type of role-specific characteristic data may be recorded. Role-specific operating resources may, for example, also be associated with the role objects. Ideally, all organizational roles of the overall organization concerned are mapped by the role objects in the role database.

In the person database, a plurality of person objects are defined, wherein each person object is associated with a natural person. The person objects typically comprise a person-specific skills profile as well as person-specific contact data. In the person objects, any further person-specific characteristic data may be recorded. Each person object is linked with at least one role object, wherein the role objects linked with the person object map the role to be performed by the respective person in the organization. Ideally, all persons directly connected with the organization concerned (employees, owner etc.) or indirectly connected therewith (subcontractors, business partners etc.) are mapped via the person objects of the person database. At least all persons performing or adapted to perform a functional role within the organization can, for example, be mapped via the person objects of the person database.

In the process database, a plurality of process objects are defined, wherein each process object maps a unique organizational process, i.e., an operative process within the respective organization. The mapped organizational process may be a simple work instruction, but may, for example, also represent a complex project planning including a plurality of subtasks and/or subordinate processes. Each process object is linked with at least one role object, wherein the role objects linked with the process object map the roles required for the operative execution of the respective organizational processes. At least the role of a process owner is hereby associated with each process object. Each process object typically comprises at least one work instruction to be executed and/or at least one target to be achieved (a so-called milestone). Process-specific operating resources may further be associated with the process objects, or any other process-specific characteristic data may be recorded in the process objects. Process objects can be “triggered” to start the respective organizational process. Process objects can hereby be triggered several times for starting the same organizational process several times. The triggering of a process object is generally mapped in the process database. For example, when the process object is triggered, a process instance associated with the process object can be generated. When the process object is triggered, additional process information is typically recorded in the respective process object, the triggering typically causes process targets, for example, to be defined. The process objects of the process database ideally map all organizational processes, both actively executed and potentially executable ones, of the overall organization concerned.

In the organizational unit database, a plurality of organizational unit objects are defined, wherein each organizational unit object of an organizational unit of the organization concerned is associated with an organizational unit. The organizational units may hereby map various operative functions within the organization concerned, such as finances, marketing, logistics, etc., for example, but may also, for example, map various organization locations, organizational technologies or markets on which the organization is active. Each organizational unit object of the organizational unit database is hereby linked with at least one role object and with at least one process object, wherein the linked role objects map the organizational roles within the respective organizational unit, and wherein the linked process objects map the operative organizational processes associated with the respective organizational unit, wherein the associated organizational processes may be both processes executed within the respective organizational unit and processes executable by the respective organizational unit.

In the work management system according to the present invention, a complete digital image, a so-called “digital twin”, of the overall organization concerned is thus ideally recorded. The employees are thus not fixedly associated with a single organizational unit as usual, but are respectively associated with an organizational role. In a simple manner, the employees can thus be deployed in various processes, but also in various organizational units according to their respective competence defined by the associated role.

The method for computer-assisted work management according to the present invention comprises the following method steps:
Obtaining a process request from an organizational unit via an electronic data interface, wherein the process request includes at least one specification information and triggers a predefined process object;
Storing the at least one specification information in the triggered process object;
Identifying a process-specific role profile by evaluating all role objects linked with the triggered process object; and
Using the process-specific role profile and the at least one specification information for determining at least one role-specific task;
Linking the process object with at least one person object, wherein each of the linked person objects is respectively associated with at least one of the linked role objects;
Transmitting the at least one role-specific task to the person linked with the respective role object.

The obtained process request can be manually transmitted by a natural person associated with the respective organizational unit object, or the obtained process can be automatically transmitted by a process associated with the respective organizational unit. The process specification included in the process request hereby generally comprises at least one process target. The process request may further comprise role or person information.

The process request triggers a predefined process object, wherein the information included in the process request, in particular the specification information, is stored in the triggered process object. Typically, when the process object is triggered, a request-specific process instance subordinate to the respective process object is generated, in which the request-specific information is stored. Alternatively, the information can also be directly stored in the respective process object. The stored request information is in any case adapted to be uniquely associated with the respective process object.

By evaluating all role objects linked with the triggered process object, both the predefined role objects and the role objects potentially transmitted with the request, a process-specific role profile is generated which maps all organizational roles required for the execution of the triggered process.

The process-specific role profile and the process information recorded in the triggered process object, in particular the specification information, is used to determine a role-specific task for at least one role linked with the triggered process. A role-specific task is typically determined for each role linked with the triggered process. The role-specific task hereby defines a task which is to be handled by a person performing the respective organizational role within the framework of process handling.

The process object is linked with at least one person object, wherein each of the linked person objects is respectively associated with at least one of the linked role objects. Exactly one person object is typically associated with each linked role object. The person objects linked with the triggered process object map the natural persons performing, within the framework of process handling, the organizational role defined by the role object linked with the person object. It is thus uniquely recorded in the process object which natural person performs which organizational role within the framework of process handling. Via the role-specific task, a unique task is further assigned to each natural person participating in the process handling.

The at least one role-specific task is allocated to the person linked with the respective role object, i.e., the person performing the respective role within the framework of process handling. A role-specific task corresponding to his/her organizational role is typically allocated to the natural person linked with the process. The allocation of the task hereby typically takes place in-system, for example, by providing a respective message on the workplace computer associated with a person and appertaining to the work management system.

The method for computer-assisted work management according to the present invention enables, in a simple manner, an efficient work management, in particular also across different organizational units, whereby the use of resources of the overall organization, in particular the use of electric energy, and the number of technical operating resources, such as computers, can be significantly reduced. As a result, the method for computer-assisted work management according to the present invention enables a particularly inexpensive and resource-saving process handling. This in turn, for example, provides an inexpensive and efficient component development and/or component manufacture. The actual cost and resource requirements of, for example, designing a new product immediately becomes transparent and trackable.

The following method steps can, for example, be further provided:
Preparing at least one role tender on the basis of the process-specific role profile;
Providing the at least one role tender to at least one person defined in the person database;
Receiving at least one answer to the tender; and
Linking the process object with at least one person object on the basis of the at least one answer to the tender.

At least one role tender is prepared on the basis of the process-specific role profile. A role tender is typically prepared for each role object linked with the process object. The role tender also generally includes, besides the role definition, the role-specific task and may include further process-specific information.

Each role tender is automatically provided to at least one person defined in the person database and linked with the respective role. All role tenders are typically automatically provided to all persons of the person database linked with the respective role. In this manner, all persons suitable for performing the respective task are ideally automatically informed by the work management system according to the present invention of the role tender, i.e., of functional organizational roles to be performed.

When a role tender is provided, an answer to the tender from at least one person associated with the respective process object is received. Several answers to the role tender are frequently received from various persons suitable for potentially performing the respective role.

On the basis of at least one answer to the tender, at least one person object is associated with the triggered process object. Exactly one person object is typically associated with the triggered process object for each role object, so that exactly one person is associated with each organizational role required for the process handling of the triggered process.

This method according to the present invention provides a particularly efficient and thus inexpensive as well as energy- and resource-saving work management and process handling. The cost/benefit of each person can thereby easily be determined as can whether or not a person who is suitable for potentially performing the respective role provides an answer to a role tender.

The work management system can, for example, comprise an applicant portal which can be accessed by least one person defined in the person database, wherein the role tender is provided in the applicant portal. This in particular provides for an energy- and resource-saving providing of the role tender. Via the applicant portal, at least one answer to the tender can also be received in a simple manner so that no additional means need be provided therefor.

The work management system can, for example, comprise an resource database in which the resource objects are defined. Each resource object of the resource database is hereby associated with an operating resource of the organization concerned. All operating resources of the overall organization concerned are ideally mapped in the resource database. Operating resources may hereby be devices, such as computers or test equipment, for example, but may also be software products. At least one role object is further linked with at least one resource object. Each role object is typically linked with at least one resource object. The resource objects linked with a role objects hereby map the operating resources required for performing the respective organizational role. According to the present invention, the following method steps are provided:
Identifying a role-specific operating resource profile by evaluating all resource objects linked with a role object; and
Providing the role-specific operating resources to the person linked with the respective role object.

For each role object linked with the triggered process object, a role-specific operating resource profile is prepared in which the resource objects linked with the respective role objects are evaluated. The role-specific operating resource profile thus uniquely defines which operating resources are required for performing a particular role.

According to the role-specific operating resource profile, at least one operating resource is provided to at least one person linked with a role object. For all role objects linked with the triggered process object, all operating resources required according to the role-specific operating resource profile for the respective role are, for example, provided to the respective person linked with the role object. For each person performing a role within the framework of the triggered process, all operating resources required for performing the respective role are, for example, thus automatically, provided. This provides a particularly inexpensive and efficient management of the operating resources. The method according to the present invention also generally provides a particularly efficient utilization of the operating means and thus a reduction of the overall consumption of the operating resources.

The work management system typically comprises at least one workplace computer system and the operating resource profile typically comprises at least one computer program, such as, for example, a special CAD-application or data processing application. In the method according to the present invention, the at least one computer program included in the role-specific operating resource profile can, for example, be automatically provided on the workplace computer system at which the person linked with the respective role profile works or is to work. All computer programs required for performing the respective role can, for example, be included in the role-specific operating resource profile, and they are automatically provided on the workplace computer system used by the respective person. No additional resources thus need be provided for the configuration of the at least one workplace computer system. This method according to the present invention thus provides, in a simple manner, the shared use of a workplace computer system by several persons, whereby the number of required workplace computer systems can be significantly reduced.

In the method according to the present invention, the work management system can, for example, automatically trigger at least one process object defined in the process database. This provides a particularly exact mapping of the organizational processes. This also leads to a high degree of automation of the organizational processes, which provides a particularly inexpensive and resource-saving work management.

In the method according to the present invention, the following method steps can, for example, be provided:
Logging in a person at the work management system by entering a person information;
Evaluating the person information for determining a respective person object;
Logging in the person at a process object linked with the person object by entering a process information.

For handling a process, a person defined in the person database logs himself/herself in at the work management system by entering a respective person information, for example, by entering a combination of a user name and a personal password.

The entered person information is evaluated by the work management system for determining a person object corresponding to the person information. The logged-in person is thus uniquely associated with a person object defined in the person database.

Subsequently, the person is logged in by entering a process information at a process object linked with the respective person object. This can, for example, be carried out by entering the process information in a simple manner via a drop-down menu in which all processes linked with the person object of the logged-in person can be selected.

Since the logged-in person is uniquely associated with a person object as well as a process object in this method according to the present invention, all activities performed by the person can, for example, be automatically protocolled by the work management system in person-specific and process-specific protocol files. The protocol files can thus be analyzed in a simple manner, for example, automatically, and hence in a resource-saving manner, whereby a particularly inexpensive and resource-saving work management is possible.

The work management system can, for example, comprise a timekeeping means (i.e., timekeeping hardware and/or software) which are included in the following steps of the method according to the present invention:
Starting a person-specific and process-specific timekeeping by the timekeeping means;
Logging off the person from the process object;
Stopping the timekeeping by the timekeeping means;
Storing the registered working time in the respective person object and/or the respective process object.

During login or immediately after login of the person at the process object, the work management system typically automatically starts a person-specific and process-specific timekeeping. During logoff or immediately after logoff of the respective person from the process object, the timekeeping is automatically stopped by the work management system. Logoff from the process object can hereby be manually performed by the employee or can be automatically performed by the work management system when the employee does not execute any process activity within a predefined inactivity period, i.e., when the work management system does not, for example, detect any entry by the employee during the inactivity period. The working time registered by the timekeeping means is automatically stored in the respective person object and/or the respective process object or at least uniquely linked with the respective person object and/or the respective process object. No additional means thus need to be provided for timekeeping. The working time stored in the work management system can thus be evaluated in a simple manner, for example, automatically. This provides a particularly efficient, inexpensive and resource-saving work flow management.

The work management system according to the present invention for computer-assisted work management comprises a server computer system including an resource database, a role database, a person database and a process database. A computer system is to be understood as any type of device suitable for executing computer programs, such as, for example, so-called personal computers (PC), notebooks, tablets, cell phones etc. A server computer system may hereby be constituted of a plurality of individual computer systems which cooperate in a so-called computer network or computer cluster, as is typically the case in so-called computer centers which are also used, for example, for so-called cloud computing.

A plurality of resource objects are typically defined in the resource database, wherein each resource object is uniquely associated with an operating resource of the organization concerned.

A plurality of role objects are typically defined in the role database, wherein each role object is associated with a unique organizational role, i.e., a unique function within the organization, and wherein at least one operating resource is associated with at least one role object. The resource objects linked with the role object hereby map the operating resources required for the operative execution of the respective organizational role.

A plurality of person objects are typically stored in the person database, wherein each person object is uniquely associated with a natural person and is linked with at least one role object. The role objects linked with the person object hereby map the roles to be performed by the respective person in the organization.

A plurality of process objects are typically defined in the process database, wherein each process object maps a unique organizational process, i.e., an operative process within the organization concerned, and wherein each process object is linked with at least one role object. The role objects linked with the process object hereby map the organizational roles required for the operative execution of the respective organizational process.

For a detailed description, reference is made to the above explanations concerning the respective databases.

The work management system for computer-assisted work management according to the present invention further comprises at least one workplace computer system connected to the server computer system, and a data entry device for entering a person information and a process information. The work management system according to the present invention typically comprises a plurality of workplace computer systems, wherein each individual workplace computer system is connected to the server computer system and comprises a data entry device for entering a person information and a process information. The server computer system and the at least one workplace computer system are hereby typically disposed at different locations and are interconnected, for example, via a local area network (LAN), via a so-called wide area network (WAN) and/or via the internet. Mobile workplace computer systems may in particular be connected to the server computer system via a mobile radio link.

According to the present invention, the at least one work management system is configured to determine a respective person object defined in the person database by evaluating the person information and to determine a respective process object by evaluating the process information.

According to the present invention, the at least one work management system is further configured to associate the determined person object with the role object linked with the determined process object and to automatically provide all operating resources linked with this role object to the workplace computer system.

The work management system according to the present invention is thus configured to automatically provide all required operating resources to the workplace computer system or the person working at the workplace computer system. This in particular includes the automatic installation of required computer programs on the workplace computer system. The work management system according to the present invention thus provides a simple and efficient use of the workplace computer system by different persons, whereby the total number of required workplace computer systems can be reduced. This leads to an inexpensive and resource-saving work management system.

The method for computer-assisted work management according to the present invention and/or the work management system according to the present invention can, for example, be used to develop and/or to produce a tangible (or intangible) product, wherein the product development and/or product manufacturing cost are entirely transparent and, as a result, can be significantly reduced. For example, the time spent by each employee to develop the product (which can be any product such as a pump, a sensor, an automobile part, a manual etc.), and in turn the cost associated therewith, can be immediately determined not only once the product has been finally developed, but also during the development itself, in real time. The efficiencies of various employees, as well as the willingness of employees to work on tendered projects, can thereby be compared. The method for computer-assisted work management according to the present invention and/or the work management system according to the present invention can be also used to reduce paperwork and, as a result, the overall paper usage of an organization. Another advantage is that the total number of operating systems is also reduced, e.g., printers, computer systems, software licenses, office premises and equipment, which will also result in an overall power reduction (i.e., a saving of electricity) of the organization.

An exemplary embodiment of a method for computer-assisted work management according to the present invention in a work management system according to the present invention is described below with reference to the accompanying FIGURE which shows a schematic diagram of a work management system according to the present invention.

The FIGURE shows a work management system 10 comprising a server computer system 12 and a plurality of workplace computer systems 14 which are respectively connected to the server computer system 12 via an electronic data interface 15, such as, for example, a (W)LAN and/or WAN connection.

The server computer system 12 comprises an resource database 16 in which a plurality of resource objects 18 are defined, wherein each resource object 18 is uniquely associated with a real operating resource. In the present exemplary embodiment, a first resource object 18a is associated with a first computer program, in particular a project management software, a second resource object 18b is associated with a second computer program, in particular a CAD software, a third resource object 18c is associated with a third computer program, in particular a data analysis software, and a fourth resource object 18d is associated with a measuring device.

The server computer system 12 further comprises a role database 20, in which a plurality of role objects 22 are defined, wherein each role object 22 maps a unique organizational role. In the present exemplary embodiment, a first role object 22a maps the organizational role “Head of Market Europe”, a second role object 22b maps the organizational role 22b “Development Engineer Rotary Encoder”, a third role object 22c maps the organizational role “Test Engineer Rotary Encoder”, a fourth role object 22d maps the organizational role “Head of Technology Rotary Encoder”, and a fifth role object 22e maps the organizational role “Management Measuring Devices Rotary Encoder”.

The server computer system 12 further comprises a person database 24 in which a plurality of person objects 26 are defined, wherein each person object 26 is uniquely associated with a natural person. In the present exemplary embodiment, a first person object 26a is associated with a first employee, a second person object 26b is associated with a second employee, a third person object 26c is associated with a third employee, a fourth person object 26d is associated with a fourth employee, and a fifth person object 26e is associated with a fifth employee.

The server computer system 12 further comprises a process database 28 in which a plurality of process objects 30 are defined, wherein each process object 30 maps a unique organizational process. In the present exemplary embodiment, a first process object 30a maps an organizational process “Product Creation”, and a second process object 30b maps an organizational process “Providing of Devices”.

The server computer system 12 further comprises an organizational unit database 32 in which a plurality of organizational unit objects 34 are defined. In the present exemplary embodiment, a first organizational unit object 34a maps an organizational unit “Market Europe”, and a second organizational unit 34b maps an organizational unit “Technology Rotary Encoder”.

In the present exemplary embodiment, the first role object 22a is linked with the first resource object 18a, the second role object 22b is linked with the second resource object 18b, the third role object 22c is linked with the third resource object 18c and with the fourth resource object 18d, and the fourth role object 18d is linked with the first resource object 18a.

In the present exemplary embodiment, the first person object 26a is linked with the first role object 22a, the second person object 26b is linked with the second role object 22b, the third person object 26c is linked with the third role object 22c, the fourth person object 26d is linked with the fourth role object 22d, and the fifth person object 26e is linked with the fifth role object 22e.

In the present exemplary embodiment, the first process object 30a is linked with the role objects 22b, 22c, the second process object 30b is linked with the fifth role object 22e and with the fifth person object 26e.

In the present exemplary embodiment, the first organizational unit object 34a is linked with the first role object 22a, with the first person object 26a as well as with the first process object 30a, and the second organizational unit object 34b is linked with the fourth role object 22d, with the fourth person object 26d as well as with the process objects 30a, 30b.

The server computer system 12 further comprises an applicant portal 38 which can be accessed by all persons defined in the person database 24, for example, via the workplace computer system 14.

The server computer system 12 further comprises a timekeeping means 40.

Each workplace computer system 14 comprises a data entry device 36 in the form of a keyboard and a mouse, via which data can be entered into the workplace computer system 14. Via the data entry device 36, a person information and a process information can in particular be entered into the workplace computer system 14.

A method for work management according to the present invention using the work management system 10 according to the present invention is exemplified below.

The work management system 10 receives, via an electronic data interface, a process request from the organizational unit “Market Europe” associated with the first organizational unit object 34a, in particular from the first employee associated with the first person object 26a linked with the first organizational object 34a.

In the present exemplary embodiment, the process request triggers the predefined first process object 30a which maps the organizational process “Product Creation”. The triggering is recorded in the first process object 30a, for example, by generating a process instance subordinate to the first process object 30a. The process request hereby includes at least one specification information, such as, for example, technical properties of the product to be created and a time for the intended completion of the product.

The obtained specification information is stored in the first process object 30a, for example, in the subordinate process instance.

By evaluating the role objects 22 linked with the first process object 30a, a process-specific role profile is identified and stored in the first process object 30a. In the present exemplary embodiment, the process-specific role profile for the process object 30a comprises the second role object 22b and the third role object 22c.

The process-specific role profile stored in the first process object 30a and the specification information stored in the first process object 30a are used to determine a respective role-specific task for the linked role objects 22b, 22c. In the present exemplary embodiment, a first task “Product Design Using CAD Software” is assigned to the second role object 22b, and a second task “Prototype Test Using Measuring Device” is assigned to the third role object 22c.

On the basis of the stored process-specific role profile, the work management system 10 automatically prepares a respective role tender for the two role objects 22b, 22c linked with the first process object 30a, whereby for the role object 22c a first role tender is prepared and for the role object 22c a second role tender is prepared. In the role tender information on the respective role-specific task, the superordinate organizational process as well as the associated organizational unit may, for example, be stated.

In the applicant portal 38 of the work management system 10, the prepared role tenders are provided to all those persons defined in the person database 24 and connected with the respective role objects 22b, 22c. In the present exemplary embodiment, the first role tender is thus provided at least to the second employee linked with the second person object 26b, and the second role tender is provided at least to the third employee linked with the third person object 26c.

A first answer to the first role tender is received from the second employee, and a second answer to the second role tender is received from the third employee. The answers to the tender can, for example, be provided to the work management system 10 directly via the applicant portal 38.

On the basis of the two received answers to the tender, the first process object 30a is linked with the second person object 26b and with the third person object 26c, wherein the second person object 26b is, in-process, associated with the second role profile 22b, and the third person object 26c is, in-process, associated with the third role object 22c. It is thus recorded in the process object 30a that, within the framework of this organizational process, the second employee performs the role “Development Engineer Rotary Encoder” and the third employee performs the role “Test Engineer Rotary Encoder”.

The work management system 10 automatically transmits, in-process, the role-specific tasks to the persons linked with the respective role object 22. The role-specific task “Product Design Using CAD-Software” associated with the second role object 22b is consequently transmitted to the second employee, and the role-specific task “Prototype Test Using Measuring Device” associated with the third role object 22c is consequently transmitted to the third employee. The transmission can hereby be carried out, for example, directly via the applicant portal 38 and/or by an electronic message (for example, by email).

For handling the respective task, the employees log into the work management system 10 by respectively entering a specific person information, wherein, in the present exemplary embodiment, the second employee logs in via a first workplace computer system 14a, and the third employee logs in via a second workplace computer system 14b. In the present exemplary embodiment, the person information is a combination of a person-related user name as well as an appertaining personal password.

The work management system 10 evaluates the entered person information of the employee and determines a person object 26 uniquely associated with the logged-in employee. For example, for the second employee the second person object 26b is determined, and for the third employee the third person object 26c is determined.

The employee further logs in by entering a process information at a process object linked with the respective person object 26. In the present exemplary embodiment, the logged-in employees are shown a respective list by the work management system 10 in which all process objects 30 linked with the respective person object 24 are indicated. In this case, the process information is entered by selecting a process object 30 from the list. In the present exemplary embodiment, the second employee and the third employee respectively log in at the process object 30a.

When the employee logs in at the process object 30, the timekeeping means 40 of the work management system 10 automatically starts a person-specific and process-specific timekeeping.

The work management system 10 determines the role object 24 which is, in-process, associated with the logged-in employee. For this role object 22, a role-specific operating resource profile is prepared by evaluating all resource objects 18 linked with this role object 22. In the present exemplary embodiment, for the second employee, the second role object 22b is determined, and for the third employee, the third role object 22c is determined. The role-specific operating resource profile for the second employee logged in at the first process object 30a consequently comprises the second resource object 18b, i.e., the second computer program, and the role-specific operating resource profile for the third employee logged in at the first process object 30a consequently comprises the third resource object 18c as well as the fourth resource object 18d, i.e., the third computer program as well as the measuring device.

The work management system 10 automatically provides to the logged-in employee the role-specific operating resource corresponding to his/her role which has been associated in-process. In the present exemplary embodiment, the work management system 10 automatically provides the second computer program for the second employee on the first workplace computer system 14a, and provides the third computer program for the third employee on the second workplace computer system 14b. The work management system 10 further automatically triggers the second process object 30b “Providing of Device” for the measuring device to be made available to the third employee.

If the employee at any time logs off from the process object 30b, the respective person-specific and process-specific timekeeping is automatically stopped. In the present exemplary embodiment, the registered working time is automatically stored by the timekeeping means 40 in the respective person object 26 as well as in the respective process object 30. The time the second employee worked on the first process object 30a is consequently stored in the second person object 26b as well as in the first process object 30a, and the time the third employee worked on the first process object 30a is consequently stored in the third person object 26c and well as in the first process object 30a. The method of the present invention therefore provides accurate, transparent and up-to-date cost and working time information.

It should be clear that the method steps of the method according to the present invention need not necessarily be carried out in the above described order. Not all method steps need be carried out simultaneously for all objects linked with a process object, but can be carried out one after the other for the individual objects.

The present invention is not limited to embodiments described herein; reference should be had to the appended claims.

### LIST OF REFERENCE NUMERALS

10 Work management system
12 Server computer system
14 Workplace computer system
14a First workplace computer system
14b Second workplace computer system
15 Electronic data interface
16 Resource database
18 Resource objects
20 Role database
22 Role objects
24 Person database
26 Person objects
28 Process database
30 Process objects
32 Organizational unit database
34 Organizational unit objects
36 Data entry device
38 Applicant portal
40 Timekeeping means

What is claimed is:

1. A method for a computer-assisted work management in a work management system, the work management system comprising:
a role database in which role objects are defined;
a person database in which person objects are defined, each of the person objects being associated with a natural person and being linked with at least one of the role objects;
a process database in which process objects are defined, each of the process objects being linked with at least one of the role objects; and
an organizational unit database in which organizational unit objects are defined, each of the organizational unit objects being linked with at least one of the role objects and with at least one of the process objects,
the method comprising:
receiving a process request from an organizational unit via an electronic data interface, the process request comprising at least one specification information and triggering a predefined process object of the process objects;
storing the at least one specification information in the predefined process object which was triggered;
determining a process-specific role profile by evaluating all role objects linked with the predefined process object which was triggered;
determining at least one role-specific task using the process-specific role profile and the at least one specification information;
linking the predefined process object with at least one of the person objects, each of the linked at least one person objects being respectively associated with at least one of the role objects linked with the predefined process object which was triggered; and
providing the at least one role-specific task to the natural person who is linked with the respective role object of the roll objects.

2. The method as recited in claim 1, further comprising:
preparing at least one role tender based on the process-specific role profile;
providing the at least one role tender to at least one natural person defined in the person database; and
receiving at least one tender reply,
wherein,
the linking of the predefined process object with at least one of the person objects is based on the at least one tender reply.

3. The method as recited in claim 2, wherein,
the work management system further comprises an applicant portal which can be accessed by at least one natural person defined in the person database, and
the at least one role tender is provided in the applicant portal.

4. The method as recited in claim 1, wherein,
the work management system further comprises:
a resource database in which resource objects are defined, each of the resource objects being associated with an operating resource, at least one of the role objects being linked with at least one resource object of the resource objects, and
the method further comprises:
evaluating all of the resource objects linked with a role object of the role objects to determine a role-specific resource profile; and
providing role-specific resources to the natural person linked with the respective role object.

5. The method as recited in claim 4, wherein,
the work management system further comprises:
at least one workplace computer system,
wherein,
the role-specific resource profile comprises at least one computer program, and
the at least one computer program is automatically provided on the at least one workplace computer system.

6. The method as recited in claim 1, wherein the triggering of the predefined process object of the process objects is triggered automatically by the work management system.

7. The method as recited in claim 1, further comprising:
logging on a natural person at the work management system by entering a person information;
evaluating the person information to determine a person object of the person objects; and
logging on the natural person at the predefined process object which is linked with the person object by entering a process information.

8. The method as recited in claim 7, wherein,
the work management system further comprises:
a timekeeping means, and
the method further comprises:
starting a person-specific and process-specific timekeeping via the timekeeping means;
logging off the natural person from the predefined process object;
stopping the timekeeping via the timekeeping means;
determining a working time; and
storing the working time determined in at least one of the person object linked with the predefined process object and/or in the predefined process object.

9. A work management system for a computer-assisted work management, the work management system comprising:
a server computer system comprising:
a resource database in which resource objects are defined, each of the resource objects being associated with an operating resource;
a role database in which role objects are defined, at least one of the resource objects being associated with at least one of the role objects;
a person database in which person objects are defined, each of the person objects being associated with a natural person and being linked with at least one of the role objects; and
a process database in which process objects are defined, each of the process objects being linked with at least one of the role objects; and
at least one workplace computer system which is connected to the server computer system, the at least one workplace computer system comprising a data input device for inputting a person information and a process information, the work management system being configured to,
determine a person object of the person objects and a process object of the process objects by evaluating the person information and the process information,
associate the person object determined to a role object which is linked with the process object determined, and
automatically provide all resources linked with the role object to the workplace computer system.
